(19) United States
(12) Patent Application Publication
(10) Pub. No.: US 2012/0061976 A1
(43) Pub. Date: Mar. 15, 2012

(54) VEHICLE DOOR LATCH

(76) Inventors: Carlos I. Tostado, Juarez (MX); Donald M. Perkins, Sterling Heights, MI (US); Francisco J. Lujan, Juarez (MX)

(21) Appl. No.: 13/175,299

(22) Filed: Jul. 1, 2011

Related U.S. Application Data
(60) Provisional application No. 61/360,698, filed on Jul. 1, 2010.

(51) Int. Cl. E05C 3/16; E05C 21/00

(52) U.S. Cl. 292/200; 292/2

(57) ABSTRACT

A vehicle door latch assembly is provided, the latch assembly having: a forkbolt movably secured to the latch assembly, the forkbolt being capable of movement between a latched position and an unlatched position; a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; an intermittent lever for providing actuation forces to the detent lever to move it from the engaged position to the disengaged position; and a means for coupling and uncoupling the intermittent lever to the detent lever.

### CROSS REFERENCE TO RELATED APPLICATIONS

This application claims the benefit of U.S. Provisional Patent Application Ser. No. 61/360,698, filed Jul. 1, 2010 the contents of which are incorporated herein by reference thereto.

This application is related to the following U.S. patent application Ser. Nos. 12/633,479, filed Dec. 8, 2009; 12/633,484, filed Dec. 8, 2009; 12/633,487, filed Dec. 8, 2009; and 12/814,688 filed Jun. 14, 2010, the contents each of which is also incorporated herein by reference thereto.

### BACKGROUND

Exemplary embodiments of the present invention relate to door and movable panel latches and, more particularly, to door and movable panel latches for vehicles.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A door latch typically includes a forkbolt that is pivoted between an unlatched position and a primary latched position when the door is closed to latch the door in the closed position. The forkbolt is typically held in the primary latched position by a detent lever that pivots between an engaged position and a disengaged position. The detent lever holds the forkbolt in the primary latched position when in the engaged position and releases the forkbolt when in the disengaged position so that the door can be opened.

The forkbolt is pivoted to the primary latched position by a striker attached to, for example, an associated door jamb when the door is closed. Once in the primary latched position, the detent lever engages the forkbolt to ensure the assembly remains latched.

Accordingly, it is desirable to provide a vehicle latch assembly that ensures proper operation of the latch in a variety of conditions.

### SUMMARY OF THE INVENTION

In one exemplary embodiment a vehicle door latch assembly is provided, the latch assembly having: a forkbolt movably secured to the latch assembly, the forkbolt being capable of movement between a latched position and an unlatched position; a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; an intermittent lever for providing actuation forces to the detent lever to move it from the engaged position to the disengaged position; and a means for coupling and uncoupling the intermittent lever to the detent lever.

In another embodiment, a vehicle door latch assembly is provided, the vehicle door latch assembly having: a forkbolt movably secured to the latch assembly, the forkbolt being capable of movement between a latched position and an unlatched position; a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; an intermittent lever for providing actuation forces to the detent lever to move it from the engaged position to the disengaged position; a lock shaft for coupling and uncoupling the intermittent lever to the detent lever, the lock shaft being rotatably received in the vehicle door latch assembly and configured for movement between a first position and a second position, wherein the intermittent lever is coupled to the detent lever when the lock shaft is in the first position and wherein the intermittent lever is uncoupled from the detent lever when the lock shaft is in the second position; and a key nut accessible from an exterior surface of the lock assembly for manually moving the intermittent lever between the first position and the second position.

In still another embodiment, a method of locking and unlocking a vehicle door latch assembly is provided, the method including the steps of: pivotally mounting a forkbolt to the latch assembly, the forkbolt being capable of movement between a latched position and an unlatched position; pivotally mounting a detent lever to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt; movably mounting an intermittent lever to the latch assembly for providing actuation forces to the detent lever to move it from the engaged position to the disengaged position; rotationally mounting a lock shaft to the latch assembly for coupling and uncoupling the intermittent lever to the detent lever, the lock shaft being configured for movement between a first position and a second position, wherein the intermittent lever is coupled to the detent lever when the lock shaft is in the first position and wherein the intermittent lever is uncoupled from the detent lever when the lock shaft is in the second position; moving the lock shaft between the first position and the second position by an electric motor; and moving the lock shaft between the first position and the second position by a key nut accessible from an exterior surface of the lock assembly.

Additional features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIGS. 1-3 are various views of a latch assembly constructed in accordance with numerous exemplary embodiments of the present invention;

FIGS. 4 and 5 are partial internal views of latch assemblies constructed in accordance with numerous exemplary embodiments of the present invention;

FIGS. 6 and 7 illustrate an actuator system of latch assemblies constructed in accordance with numerous exemplary embodiments of the present invention;

FIGS. 8-10 illustrate a latching system of latch assemblies constructed in accordance with numerous exemplary embodiments of the present invention;

FIGS. 11-12A illustrate locked and unlocked positions of components of latch assemblies constructed in accordance with numerous exemplary embodiments of the present invention;

FIGS. 13A-13C illustrate a release lock override in accordance with numerous exemplary embodiments of the present invention;

FIGS. 14A-14G illustrate another feature of a latch assembly constructed in accordance with numerous exemplary embodiments of the present invention;

FIGS. 15A-15B illustrate a double lock feature of a latch assembly constructed in accordance with numerous exemplary embodiments of the present invention;

FIGS. 16A-16C illustrate a lock and double lock override feature of a latch assembly constructed in accordance with numerous exemplary embodiments of the present invention;

FIGS. 17A-17B illustrate a manual lock and unlock feature accessible from an exterior surface of a latch assembly constructed in accordance with numerous exemplary embodiments of the present invention;

FIGS. 18A-18C′ illustrate a key only locking feature of a latch assembly constructed in accordance with numerous exemplary embodiments of the present invention;

FIGS. 19A-19C illustrate a locking feature of a latch assembly constructed in accordance with numerous exemplary embodiments of the present invention; and

FIGS. 20A-20C illustrate a bumper for a latch assembly constructed in accordance with numerous exemplary embodiments of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Referring now the attached FIGS., various exemplary embodiments of the present invention are illustrated.

Exemplary embodiments of the present invention relate to an apparatus and method for providing a latch assembly. Furthermore, exemplary embodiments are directed to a latch assembly having a forkbolt or forkbolt lever movably secured thereto for movement between a latched position and an unlatched position. The latch assembly further comprises a detent lever capable of movement between an engaged position and a disengaged position, wherein the detent lever retains the forkbolt in the latched position when the detent lever is in the engaged position.

Referring now to the FIGS., a vehicle compartment latch or latch assembly 10 or components thereof are illustrated. In one embodiment, vehicle compartment latch 10 comprises a frame plate or support 11 that is adapted for fastening to a vehicle proximate to a compartment closure.

Reference is also made the following U.S. Pat. Nos. 6,811,193; 7,090,264; 5,520,426; 5,277,461; 5,316,354; 5,454,608; 4,969,673; 5,715,713; 5,535,607; 6,264,253; 6,749,234; and 6,733,052 the contents each of which are incorporated herein by reference thereto. Reference is also made to the following U.S. Patent Publication U.S. 2011/0101707; and pending application Ser. No. 12/814,688 filed Jun. 14, 2010, the contents each of which are also incorporated herein by reference thereto.

A forkbolt or forkbolt lever 16 is pivotally or rotationally mounted to the frame plate about a pivot pin or stud 17 or other equivalent item that is received within a pivot pin opening of the forkbolt. The forkbolt is capable of rotational movement between an open or unlatched position and a closed or latched position.

The vehicle compartment latch is attached to a vehicle structure such that forkbolt is moved between the open position and the closed position when a door, window, lift gate, etc. is opened and closed and the forkbolt engages a striker that is attached to the door, window, lift gate, etc. Alternatively, the vehicle compartment latch is secured to the door, window, lift gate, etc. and the striker is secured to the vehicle body at an opening into which the door, window, lift gate, etc. is received. The cooperation of a forkbolt and striker is well known and need not be described in detail.

The vehicle compartment latch further comprises a detent lever 24 that pivots on the support or frame plate about a pivot pin 19 or other equivalent item received within a pivot pin opening in the detent lever. The detent lever cooperates with the forkbolt to retain the forkbolt in a closed position or release the forkbolt for return movement to the open position. That is, the detent lever pivots between a closed or engaged detent position and a release or disengaged detent position.

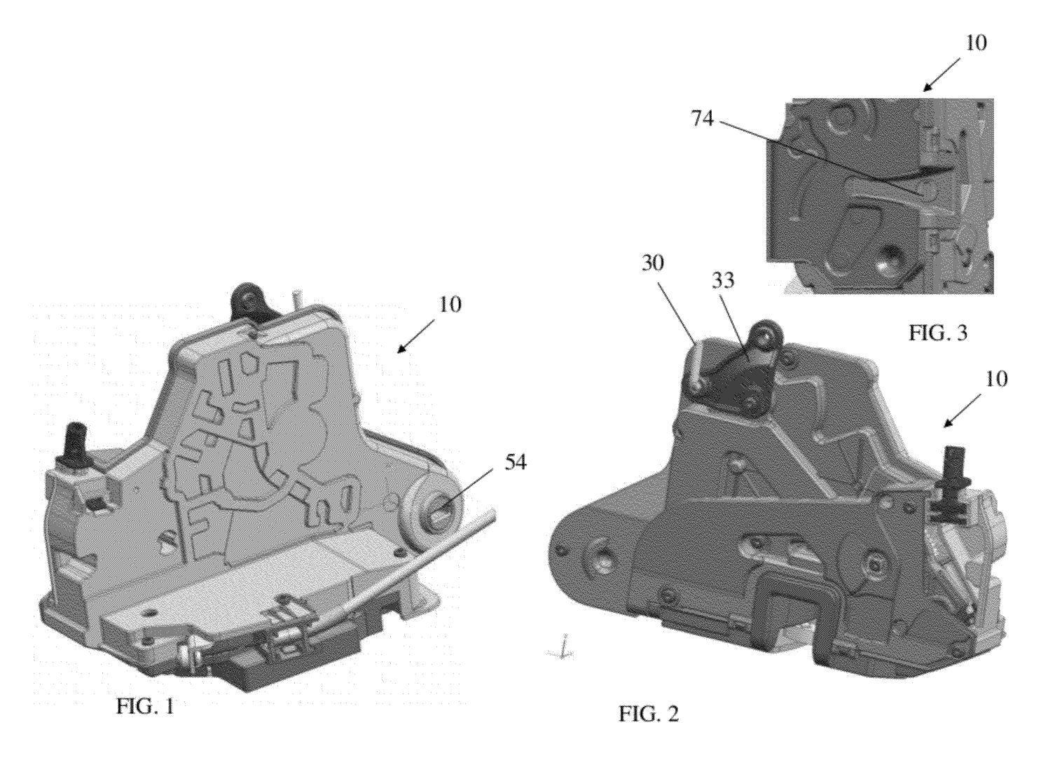

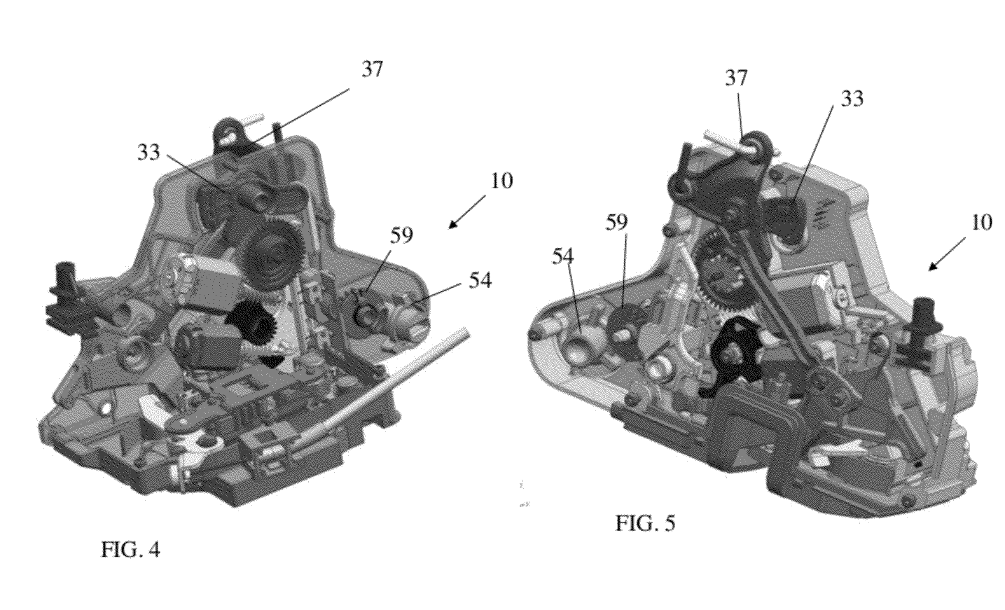

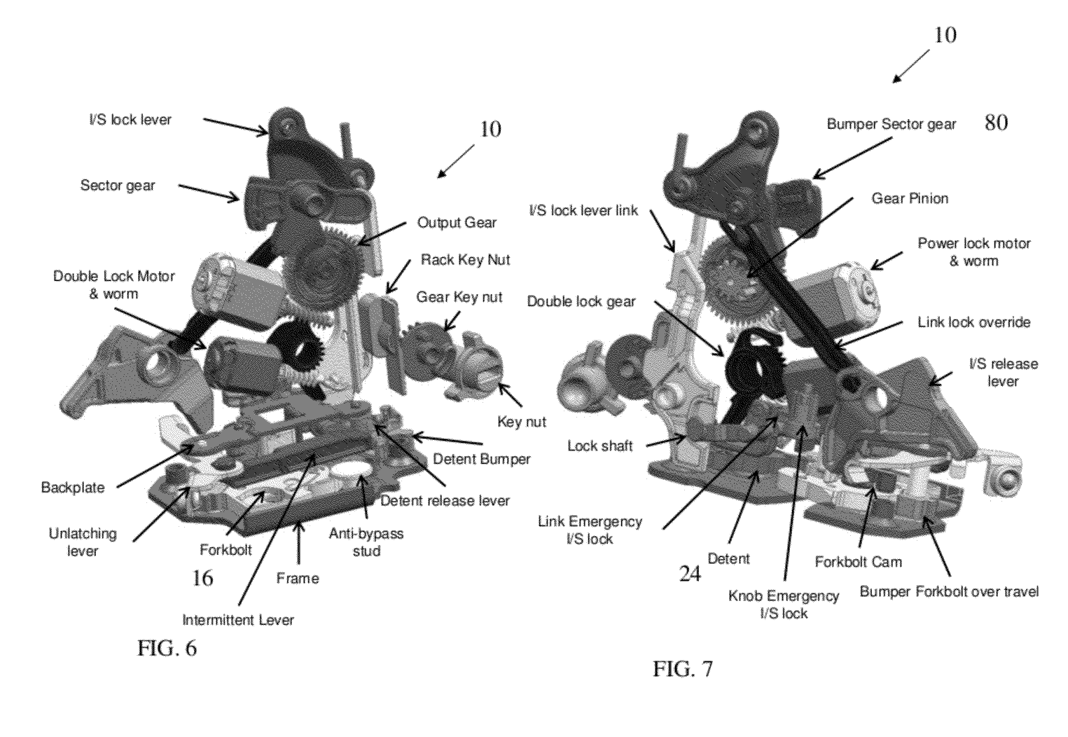

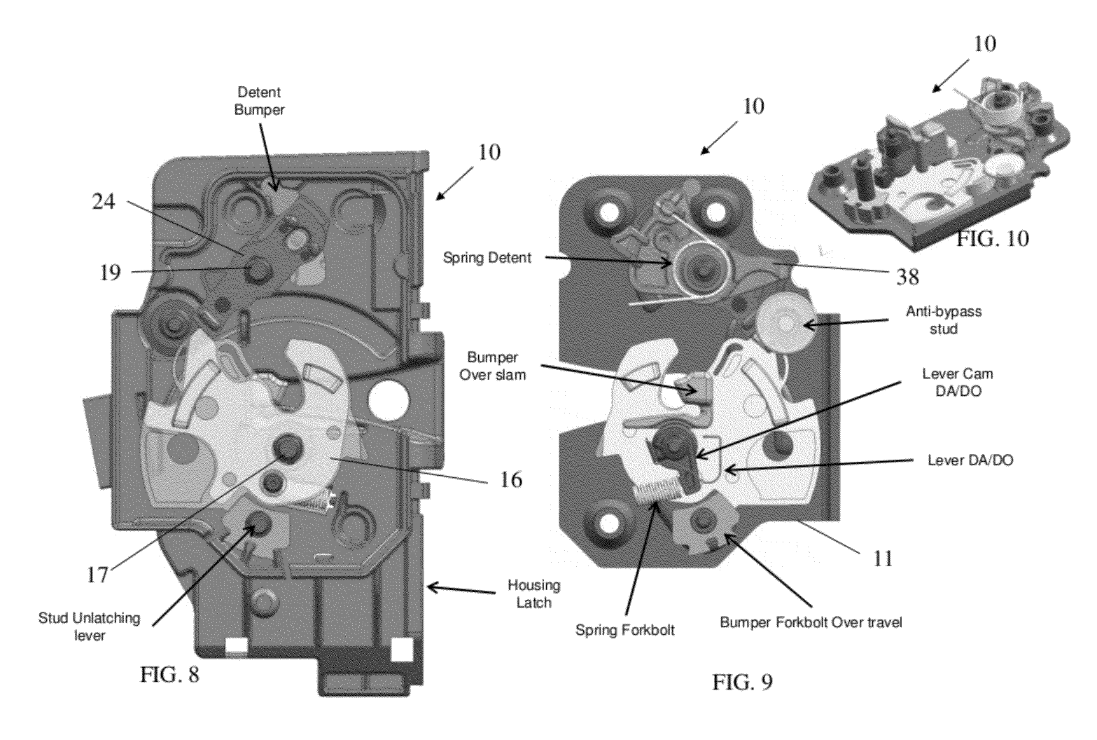

Various exemplary embodiments are illustrated in the attached drawings and referring to at least FIGS. 1-12A, a power and manual lock feature 21 with a rod 30 is illustrated. In this embodiment, the feature prevents the outside release lever to be active or to be able to unlatch the latch during lock position.

In one non-limiting exemplary embodiment, operation of the power and manual lock feature 21 from a locked position to an unlocked position is as follows: an actuator 23 comprising a power lock motor and worm 25 drives an output gear 27 and a coupled pinion gear 29 in the direction of arrow 31. Movement of the pinion gear 29 causes a sector gear 33 to rotate in the direction of arrow 35. Sector gear 33 is coupled to is coupled to an inside lock lever link 32. The inside lock lever 32 is coupled to a lock shaft 34 and the lock shaft 34 is coupled to an intermittent lever 36. In one embodiment, the inside lock lever 32 is coupled to the lock shaft 34 via a spring 58, which in some instances is labeled as the “impatient passenger spring”.

Accordingly, movement of the sector gear 33 in the direction of arrows 35 causes the inside lock lever link 32 to move in the direction of arrow 41. This movement of the inside lock lever link 32 causes rotational movement of the lock shaft 34 in the direction of arrow 43. Since the lock shaft 34 is coupled to the intermittent lever 36 the movement of the lock shaft in the direction of arrow 34 causes the intermittent lever 36 to be in the unlocked position (illustrated in at least FIG. 12A). The intermittent lever 36 is coupled to an outside lever via an unlatching lever 45. When the intermittent lever 36 is in the unlocked position, the outside lever is now active to unlatch the latch system as the intermittent lever is now in contact with the detent release lever 38 that is coupled to the detent lever 24.

Also shown is that an inside lock lever 37 is also coupled to the lock lever link 32 either directly or through sector gear 33 such that movement of the inside lock lever 37 via a cable coupled to a lock or other corresponding component will cause movement of the lock lever link 32 and ultimately the corresponding movement of the lock shaft 34.

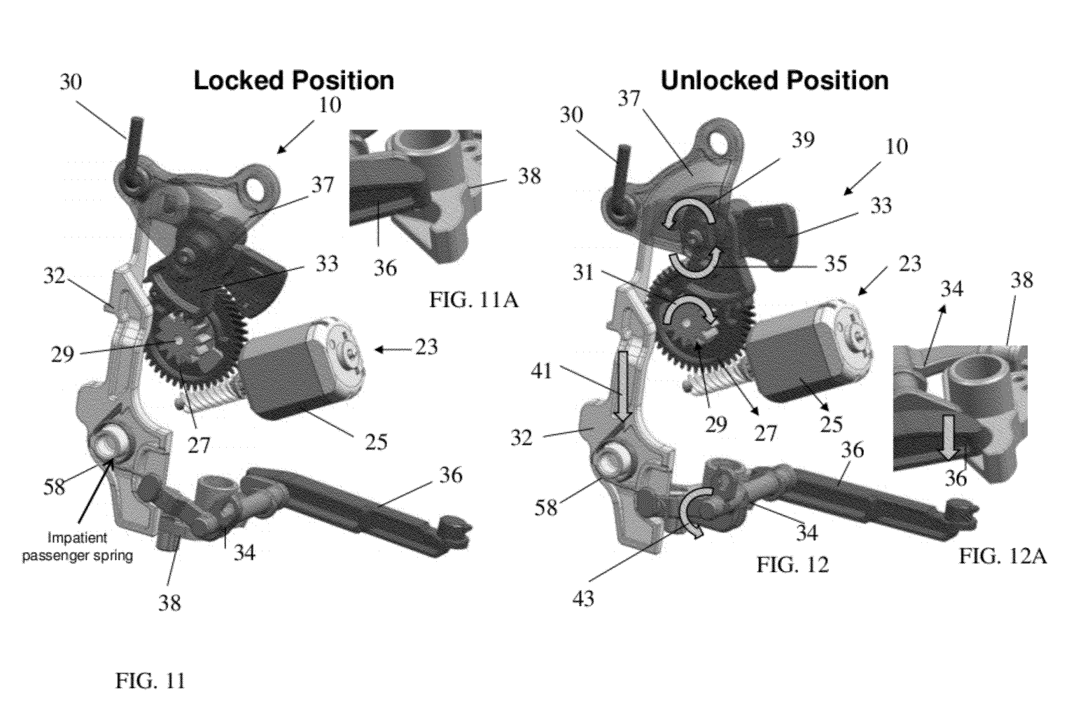

It being understood that each of the aforementioned components are pivotally, slidably, rotationally or movably secured to the latch 10 or frame 11 or a latch housing or latch component such that the aforementioned movements are capable of being made. Still further, it is understood that movement of the components from the positions in FIGS. 12 and 12A to those of 11 and 11A are also capable in addition to the movement of the components from the positions in FIGS. 11 and 11A to those of 12 and 12A (e.g., locked to unlocked and vice versa).

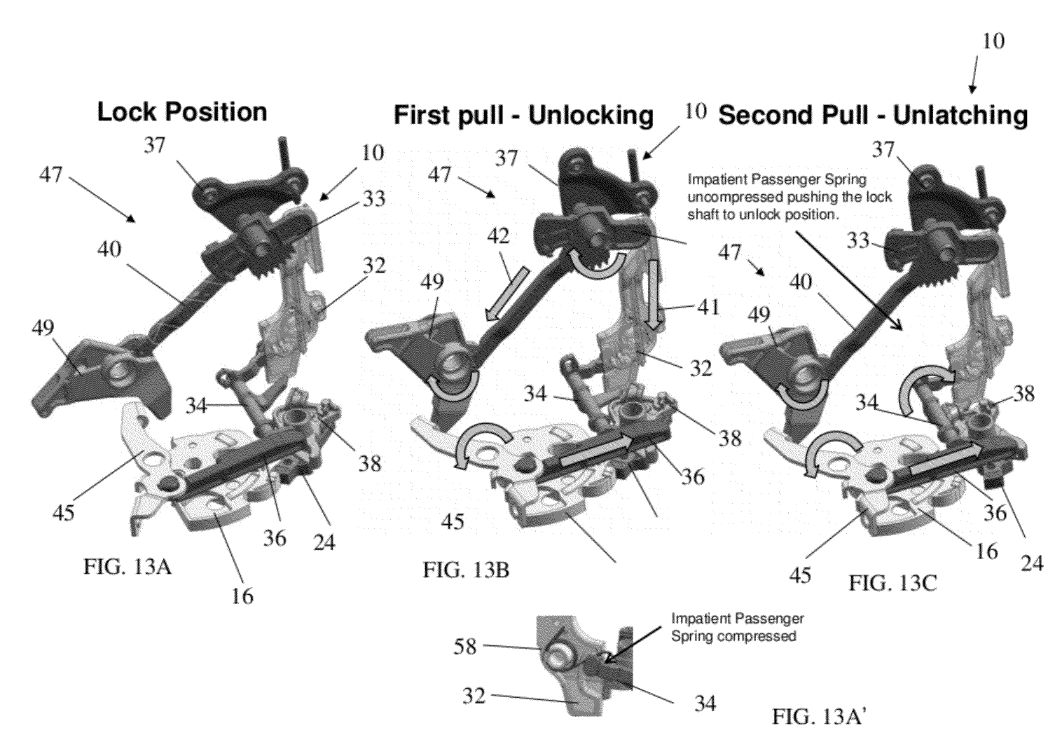

Referring now to the attached drawings and at least FIGS. 1-13C, an inside and outside release cable feature 47 is illustrated, this feature allows an unlock and release of the latch through the inside release lever 49 using two (2) pulls. In operation and when the latch 10 is in a locked position the outside handle is free wheeling and cannot be activated, during the first pull of a handle coupled to the inside release lever, the inside release lever pulls the link lock override 40 in the direction of arrow 42 moving the locking system to an unlocked position (FIG. 13B) wherein the intermittent lever 36 is in the locked position and then during the second pull (FIG. 13C) of the handle coupled to the inside release lever the latch is already in an unlocked position allowing the latch to be unlatched.

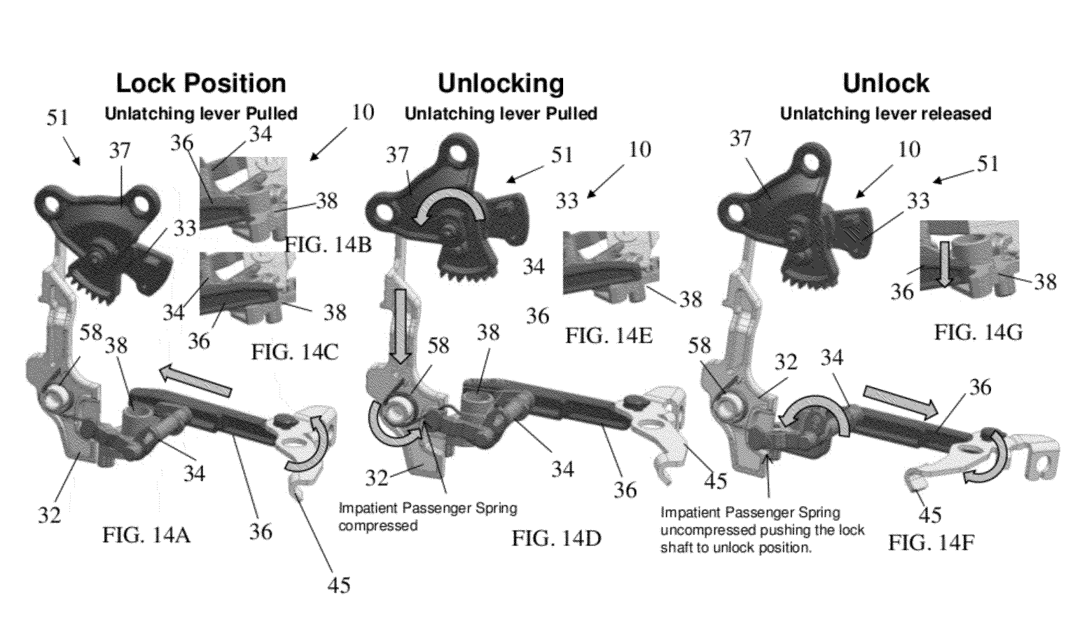

Referring now to at least FIGS. 14A-14F an impatient passenger feature 51 is illustrated. The impatient passenger feature 51 helps to unlock the system when the locking lever and unlatching system are actuated at the same time preventing the passenger unlock twice while release handles coupled to the latch assembly are pulled.

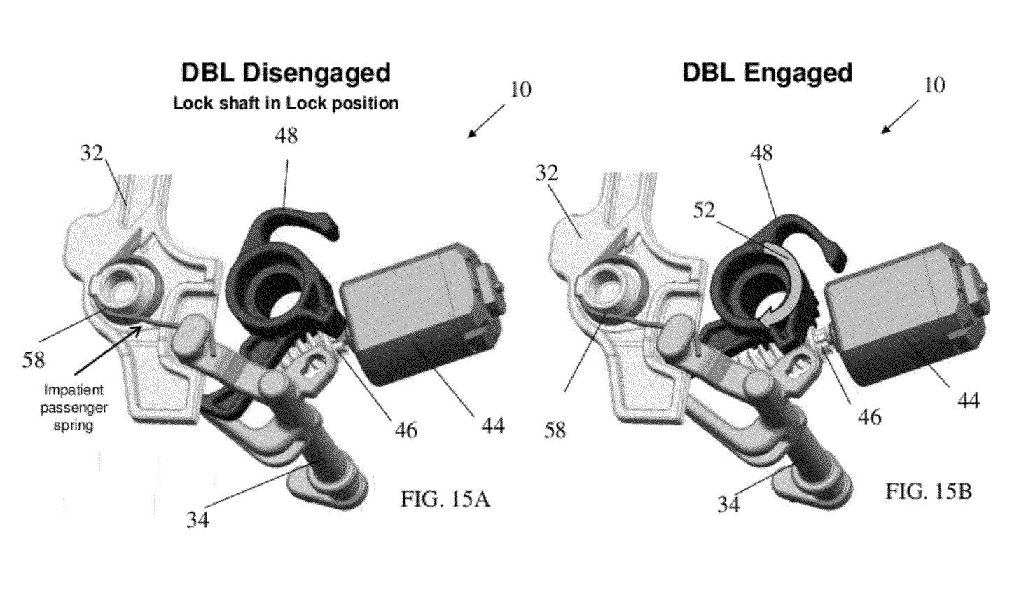

Referring now to at least FIGS. 1-15B, a double lock feature 53 is also illustrated, this feature disables the release handles leaving them free wheeling such that they cannot release the latch 10. This system becomes active with a double lock motor 44 and associated worm 46. In operation, a double lock gear 48 when in the disengaged position (DBL disengage—FIG. 15A) allows the lock shaft 34 to be in an unlock position. When activated the actuator (motor) drives the double lock lever to the locked position (FIG. 15B) in the direction of arrow 52, the lock gear 48 also blocks and keeps the lock shaft in the lock position. The inside release lever is now free wheeling and cannot release the latch and the lock function is kept active.

Referring to FIGS. 1-16C, a lock and double lock override with direct key cylinder feature 55 is illustrated, this feature overrides the double lock and is engaged manually through a key nut 54 that is rotationally secured to the latch housing. The key nut 54 has an opening or feature that can be engaged to cause the key nut 54 to be rotated by a linkage, tool or lock operated by a key or in other words a key inserted into a lock cylinder of the door, which allows for movement of the latch assembly (lock and unlock) in the event of a power loss to the vehicle. Key nut 54 has a feature accessible from an exterior surface of the lock housing. This feature is useful in case of a loss of power wherein the motor will be deactivated as the double lock feature is only activated by power or a motor, in one embodiment this system is used only on the driver side latch. Of course, it can be used on other latches.

In this embodiment, rotational movement of the key nut 54 in the direction of arrow 57 causes a portion or feature of the drive nut to engage a portion or feature of a drive gear or gear key nut 59 which has a toothed portion configured to engage a rack or race key nut 61 secured to the inside lock lever link 32. Accordingly and as illustrated in the attached FIGS., movement of the key nut 54 in the direction of arrow 57 causes movement of drive gear 59 in the direction of arrow 63 which causes movement of the rack 61 in the direction of arrow 67 and accordingly moves the lock lever link 32 in the direction of arrow 69.

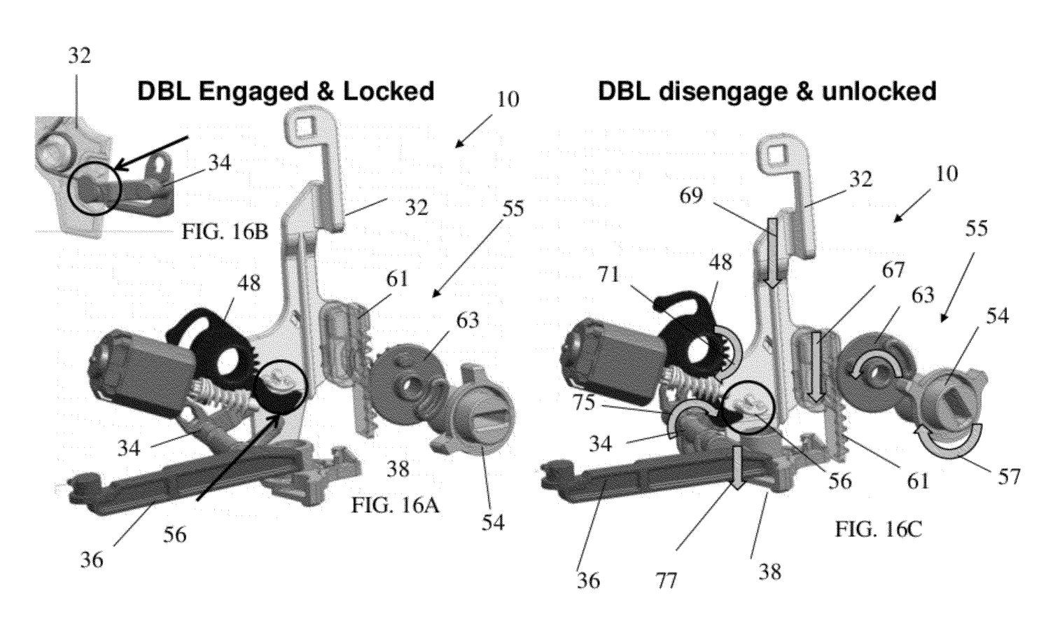

The lock lever link 32 also has a double lock (DBL) override feature 56 that pushes the double lock gear 48 in the direction of arrow 71 to a double lock disengage position (FIG. 16C) which also allows the lock shaft 32 to rotate in the direction of arrow 75 and the intermittent lever 36 to move in the direction of arrow 77 to the unlock position such that the intermittent lever 36 engages the detent release lever 38 and accordingly, the outside and inside release levers are now active and can now can release the latch as the double lock 55 is disengaged and the latch 10 is unlocked.

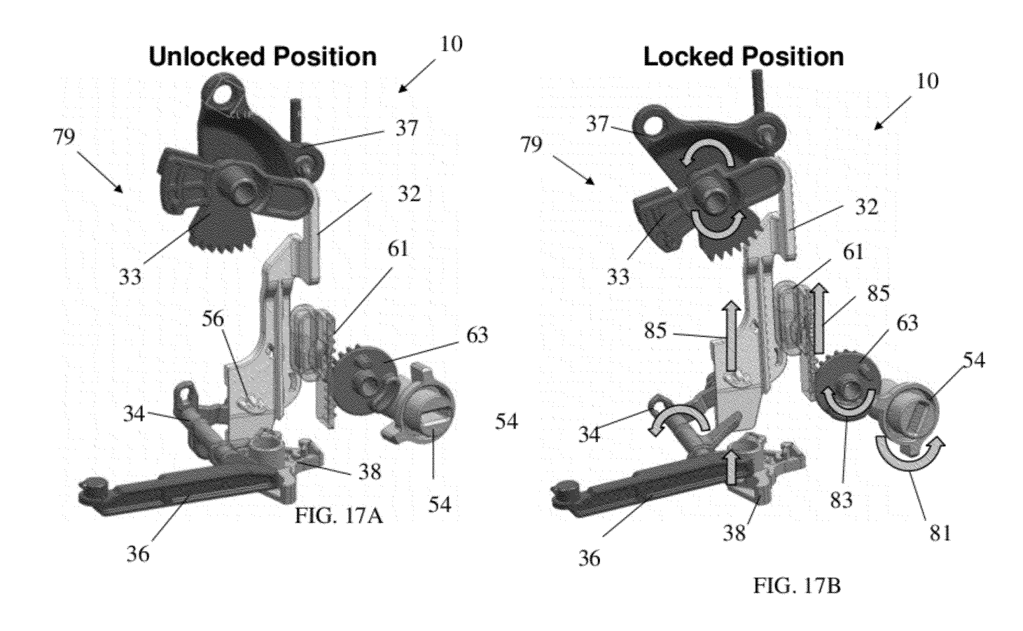

Referring to FIGS. 1-17B, a direct key cylinder feature 79 is illustrated, this feature allows locking and unlocking through the key nut in case of a loss of power. Alternatively, this feature can be used in non-power locks as well. The lock position (FIG. 17B) disables the outside release lever such that the latch assembly is now locked.

During operation and when the outside release lever is active and can release the latch (unlocked position FIG. 17A), the key nut 54 when rotated in the direction of arrow 81 drives the gear nut 63 in the direction of arrow 83 which moves the rack or race key nut 61 and accordingly the lock lever link 32 in the direction of arrow 85 causing the lock shaft 34 and the intermittent lever 36 to move to the locked position. In this position, the outside release lever is now free wheeling and cannot release the latch (Lock Position FIG. 17B).

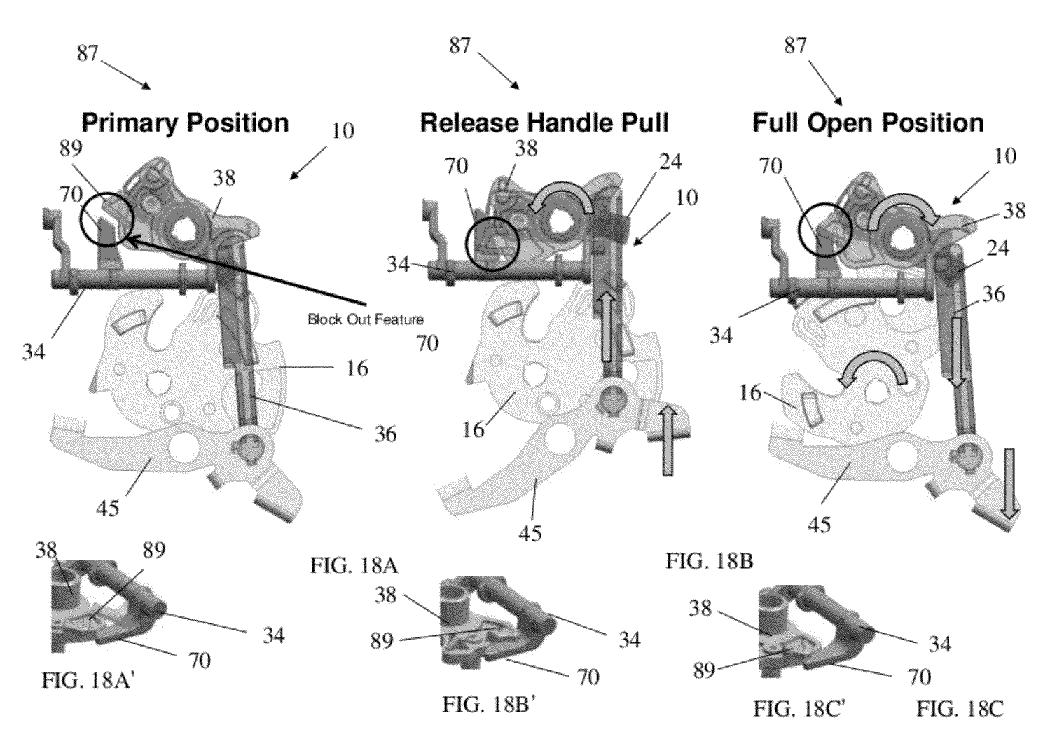

Referring to FIGS. 1-18C, a key only locking feature 87 is illustrated, this feature prevents locking of the latch 10 during release handle pulls or when the door is on full open position, avoiding undesirable locking. In other words only a key can be used to lock the latch 10.

Here, when the outside or inside handle (release handle pull) are actuated a block out feature 89 of the detent release lever 38 blocks a feature 70 of the lock shaft 34 such that the block out feature 89 is actively blocking the lock shaft 34 to prevent the latch 10 from being placed in an undesirable lock position during the handle pulls. Also when the forkbolt is in the full open position the block out feature 89 is still active. Once, the forkbolt returns to the latched or primary position the detent 24 the detent release lever 38 return to the disengaged position and the feature 89 is no longer blocking feature 70 of the lock shaft such that the same can be repositioned to place the latch assembly in a locked position. Movement of the forkbolt 16 and a spring biasing force to the detent 24 or detent release lever 38 will cause the detent 24 and detent release lever 38 to move back to the disengaged position.

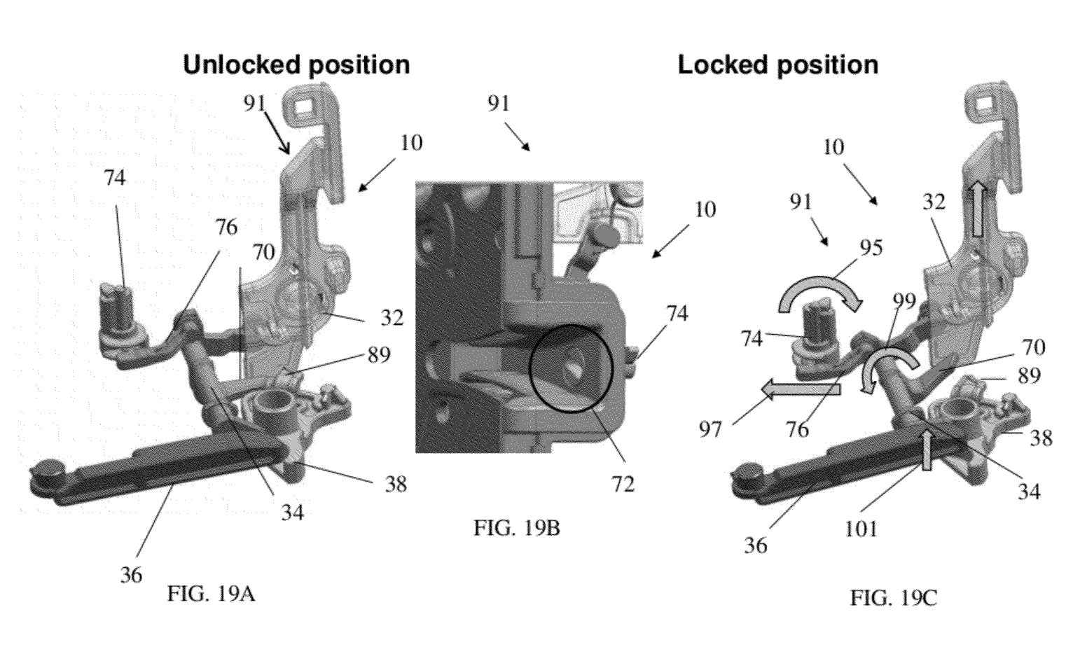

Referring to FIGS. 1-19C, an emergency inside lock feature 91 is illustrated. In the event of a loss of power this feature allows a user to lock the latch through a fish mouth striker entrance 72 of the latch 10. Accordingly, the outside release lever can be disabled and preventing unlatching of the latch through the outside handle. A knob emergency inside lock 74 is rotatably mounted to the latch 10 and as illustrated can be engaged via fish mouth striker entrance 72 of the latch 10. Of course, other locations are contemplated. Here the emergency inside lock 74 is coupled to the lock shaft 34 via an emergency inside lock link 76. The emergency inside lock 74 has a channel or feature 93 configured to engage the emergency inside lock link 76 only when the emergency inside lock 74 is rotated in one direction for example, the direction illustrated by arrow 95 which in turn moves the emergency inside lock link 76 in the direction of arrow 97 whose movement in turn rotates the lock shaft 34 in the direction of arrow 99 which in turn moves the intermittent lever 34 in the direction of arrow 101 to the locked position, wherein the outside release lever is now on free wheeling and cannot release the latch (locked position). Accordingly, an outside release handle coupled to the outside release lever cannot release the latch when the outside release lever is free wheeling.

Referring to at least FIGS. 1-20C, a bumper 80 for the power actuated latches is illustrated. The bumper is formed from two injection shots wherein a hard plastic core 82 is encapsulated by a softer plastic 84. In one non-limiting embodiment, the plastic core comprises: Santoprene 85 shore A or Hitrel 35 shore D, or another other suitable material. In one non-limiting embodiment, a softer plastic 84 encapsulates the core and comprises Santoprene 35 or 45 shore A or Hitrel 35 shore D, or another other suitable material.

The bumper is designed to meet at least two requirements, first durability to prevent damages to the components making contact with the bumper and damping the sound during actuation when the components contact the bumper.

In one embodiment, the two shot bumper is able to combine two materials of different hardness, wherein the core bumper is a hard plastic to ensure that the actuator lasts the whole life requirement without allowing the actuator components to be stressed and wherein the outer plastic encapsulation is a softer material to create a good quality actuation sound, taking into account that the encapsulation may degrade during its operational life.

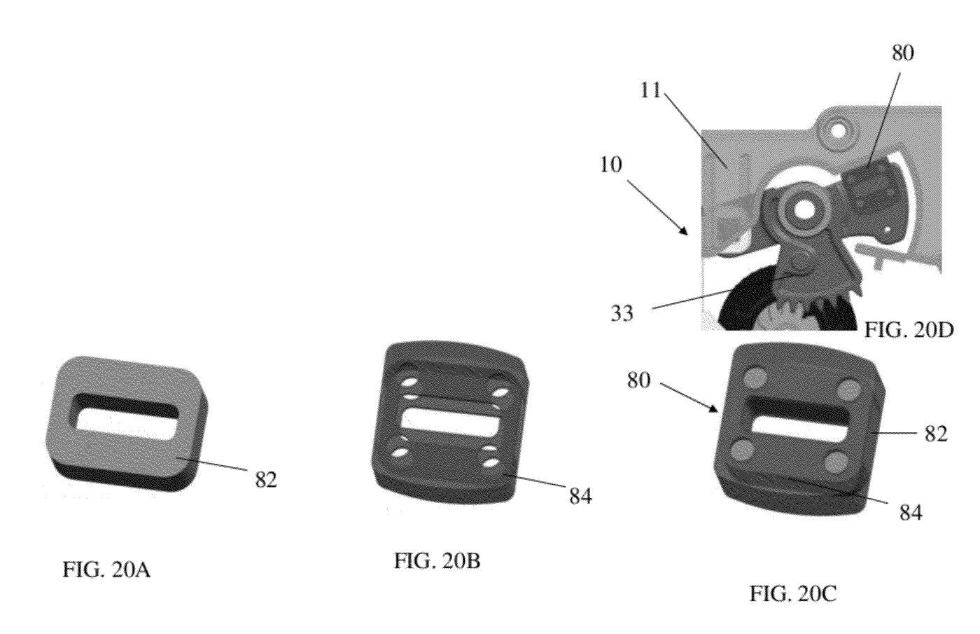

As illustrated in at least FIG. 20D the two shot bumper 80 is secured to a feature of the sector gear 33 and is configured such that the softer outer plastic is configured to engage a portion of the frame 11 of the latch as the sector gear 33 is moved to one end of its operational ranges.

Although numerous features are disclosed in the present application, it is understood that various features disclosed herein can be incorporated alone or together with other features in various combinations to provide numerous vehicle latch assemblies having various configurations of the features disclosed herein.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the appended claims.

What is claimed is:

1. A vehicle door latch assembly, comprising:
a forkbolt movably secured to the latch assembly, the forkbolt being capable of movement between a latched position and an unlatched position;
a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt;
an intermittent lever for providing actuation forces to the detent lever to move it from the engaged position to the disengaged position; and
a means for coupling and uncoupling the intermittent lever to the detent lever.

2. The vehicle door latch assembly as in claim 1, wherein the means for coupling and uncoupling the intermittent lever to the detent lever is a lock shaft rotatably received in the vehicle door latch assembly, the lock shaft being configured for movement between a first position and a second position, wherein the intermittent lever is coupled to the detent lever when the lock shaft is in the first position and wherein the intermittent lever is uncoupled from the detent lever when the lock shaft is in the second position and wherein the lock shaft is rotated between the first and second positions by an emergency lock knob accessible through a striker opening in the vehicle door latch assembly.

3. The vehicle door latch assembly as in claim 2, wherein the emergency lock knob is configured to only move the lock shaft to the second position.

4. The vehicle door latch assembly as in claim 3, wherein the emergency lock knob has a feature configured to engage a link which couples the emergency lock knob to the lock shaft.

5. The vehicle door latch assembly as in claim 4, wherein the intermittent lever is coupled to the detent lever by a detent release lever.

6. The vehicle door latch assembly as in claim 1, wherein the means for coupling and uncoupling the intermittent lever to the detent lever is a lock shaft rotatably received in the vehicle door latch assembly, the lock shaft being configured for movement between a first position and a second position, wherein the intermittent lever is coupled to the detent lever when the lock shaft is in the first position and wherein the intermittent lever is uncoupled from the detent lever when the lock shaft is in the second position and wherein the lock shaft is prevented from rotating to the second position from the first position by a double lock gear, the double lock gear moving between a lock and unlock position by a motor and the double lock gear prevents the lock shaft from rotating to the second position from the first position when the double lock gear is in the lock position, wherein the double lock gear allows the lock shaft to rotate to the second position from the first position when the double lock gear is in the unlock position and wherein the vehicle door assembly further comprises a key nut accessible from an exterior surface of the lock assembly for manually moving the double lock gear from the lock position to the unlock position.

7. The vehicle door latch assembly as in claim 6, wherein the key nut is coupled to the lock shaft by a gear nut that is rotated when the key nut is rotated and the gear nut is configured to move a rack when the gear nut is rotated and movement of the rack causes movement of a lock lever link which is coupled to the lock shaft.

8. The vehicle door latch assembly as in claim 7, wherein the lock lever link is coupled to the double lock gear.

9. The vehicle door latch assembly as in claim 8, wherein the intermittent lever is coupled to the detent lever by a detent release lever.

10. The vehicle door latch assembly as in claim 1, wherein the means for coupling and uncoupling the intermittent lever to the detent lever is a lock shaft rotatably received in the vehicle door latch assembly, the lock shaft being configured for movement between a first position and a second position, wherein the intermittent lever is coupled to the detent lever when the lock shaft is in the first position and wherein the intermittent lever is uncoupled from the detent lever when the lock shaft is in the second position and wherein the lock assembly further comprises a key nut accessible from an exterior surface of the lock assembly for manually moving lock shaft between the first and second positions.

11. The vehicle door latch assembly as in claim 10, wherein the key nut is coupled to the lock shaft by a gear nut that is rotated when the key nut is rotated and the gear nut is configured to move a rack when the gear nut is rotated and movement of the rack causes movement of a lock lever link which is coupled to the lock shaft.

12. The vehicle door latch assembly as in claim 11, wherein the intermittent lever is coupled to the detent lever by a detent release lever.

13. The vehicle door latch assembly as in claim 1, wherein the means for coupling and uncoupling the intermittent lever to the detent lever is a lock shaft rotatably received in the vehicle door latch assembly, the lock shaft being configured for movement between a first position and a second position, wherein the intermittent lever is coupled to the detent lever by a detent release lever when the lock shaft is in the first position and wherein the intermittent lever is uncoupled from the detent release lever when the lock shaft is in the second position and wherein the detent release lever further comprises a block out feature for engaging a portion of the lock shaft such that the detent release lever retains the lock shaft in the first position until the detent is moved to the engaged position through movement of the forkbolt into the latched position.

14. The vehicle door latch assembly as in claim 1, further comprising:
a motorized actuator for locking and unlocking the latch assembly by manipulating at least one movable component between a first position and a second position; and
a bumper secured to the at least one component for contacting other portions of the lock assembly as the at least one movable component is moved between the first position and the second position by the motorized actuator and wherein the bumper comprises a hard inner plastic core encapsulated by a softer outer plastic covering such that the softer outer plastic covering contacts the other portions of the lock assembly and wherein the softer outer plastic covering provides less audible noise when it contacts the other components as opposed to the hard inner plastic core.

15. The vehicle door latch assembly as in claim 14, wherein the bumper is formed from a two shot injection molding process and the bumper is secured to a sector gear that is rotated by the motorized actuator and the bumper contacts a portion of a frame of the lock assembly when the sector gear is rotated by the motorized actuator and wherein the means for coupling and uncoupling the intermittent lever to the detent lever is a lock shaft rotatably received in the vehicle door latch assembly, the lock shaft being configured for movement between a first position and a second position, wherein the intermittent lever is coupled to the detent lever when the lock shaft is in the first position and wherein the intermittent lever is uncoupled from the detent lever when the lock shaft is in the second position and wherein the lock shaft is coupled to the sector gear by a lock lever link which is coupled to the lock shaft.

16. A vehicle door latch assembly, comprising:
a forkbolt movably secured to the latch assembly, the forkbolt being capable of movement between a latched position and an unlatched position;
a detent lever movably secured to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt;
an intermittent lever for providing actuation forces to the detent lever to move it from the engaged position to the disengaged position;
a lock shaft for coupling and uncoupling the intermittent lever to the detent lever, the lock shaft being rotatably received in the vehicle door latch assembly and configured for movement between a first position and a second position, wherein the intermittent lever is coupled to the detent lever when the lock shaft is in the first position and wherein the intermittent lever is uncoupled from the detent lever when the lock shaft is in the second position; and
a key nut accessible from an exterior surface of the lock assembly for manually moving the intermittent lever between the first position and the second position.

17. A vehicle door latch assembly as in claim 16, wherein the lock shaft is also capable of being rotated from the first position to the second position by an emergency lock knob accessible through a striker opening in the vehicle door latch assembly.

18. The vehicle door latch assembly as in claim 17, wherein the intermittent lever is coupled to the detent lever by a detent release lever and wherein the detent release lever further comprises a block out feature for engaging a portion of the lock shaft such that the detent release lever retains the lock shaft in the first position until the detent is moved to the engaged position through movement of the forkbolt into the latched position.

19. The vehicle door latch assembly as in claim 18, wherein the lock shaft is prevented from rotating to the second position from the first position by a double lock gear, the double lock gear moving between a lock and unlock position by a motor and the double lock gear prevents the lock shaft from rotating to the second position from the first position when the double lock gear is in the lock position and wherein the double lock gear allows the lock shaft to rotate to the second position from the first position when the double lock gear is in the unlock position and wherein the key nut is configured to manually moving the double lock gear from the lock position to the unlock position, the key nut being coupled to the lock shaft by a gear nut that is rotated when the key nut is rotated and the gear nut is configured to move a rack when the gear nut is rotated and movement of the rack causes movement of a lock lever link which is coupled to the lock shaft, wherein the lock lever link is coupled to the double lock gear; and the vehicle door latch assembly, further comprising:
a motorized actuator for locking and unlocking the latch assembly by manipulating at sector gear coupled to the lock lever link between a first position and a second position; and
a bumper secured to the sector gear for contacting a frame of the lock assembly as the sector gear is moved between the first position and the second position by the motorized actuator and wherein the bumper comprises a hard inner plastic core encapsulated by a softer outer plastic covering such that the softer outer plastic covering contacts the other portions of the lock assembly and wherein the softer outer plastic covering provides less audible noise when it contacts the frame as opposed to the hard inner plastic core, wherein the bumper is formed from a two shot injection molding process.

20. A method of locking and unlocking a vehicle door latch assembly, comprising:
pivotally mounting a forkbolt to the latch assembly, the forkbolt being capable of movement between a latched position and an unlatched position;
pivotally mounting a detent lever to the latch assembly, the detent lever being capable of movement between an engaged position and a disengaged position, the detent lever retains the forkbolt in the latched position when the detent lever is in the engaged position and a engagement surface of the detent lever contacts an engagement surface of the forkbolt;
movably mounting an intermittent lever to the latch assembly for providing actuation forces to the detent lever to move it from the engaged position to the disengaged position;
rotationally mounting a lock shaft to the latch assembly for coupling and uncoupling the intermittent lever to the detent lever, the lock shaft being configured for movement between a first position and a second position, wherein the intermittent lever is coupled to the detent lever when the lock shaft is in the first position and wherein the intermittent lever is uncoupled from the detent lever when the lock shaft is in the second position;
moving the lock shaft between the first position and the second position by an electric motor; and
moving the lock shaft between the first position and the second position by a key nut accessible from an exterior surface of the lock assembly.
